(19) United States
(12) Patent Application Publication
(10) Pub. No.: US 2006/0280572 A1
(43) Pub. Date: Dec. 14, 2006

(54) Sleeve with indication assembly

(76) Inventor: Yu-Chun Lin, Taipei (TW)

Correspondence Address: YU-CHUN LIN, 235 Chung-Ho, Box 8-24, Taipei, TW

(21) Appl. No.: 11/447,749

(22) Filed: Jun. 7, 2006

(30) Foreign Application Priority Data
Jun. 9, 2005 (TW) 094215291

(51) Int. Cl. B23C 3/00

(52) U.S. Cl. 409/234

(57) ABSTRACT

A sleeve with an indication assembly comprises a sleeve; and a toggle having an inner diameter corresponding to an outer diameter of the sleeve; and the toggle being made of aluminum alloy; a surfaces of the toggle being anodic processed so as to form with a protection film of different colors; thus the surfaces of the toggle is prevented from cracking, collision, mist and falling off. Furthermore, in another case, the toggle has an inner diameter corresponding to an outer diameter of the sleeve; and the toggle is made of iron. A surface of the toggle is electroplated so as to form with a copper layer and then is performed with anodic processing so as to have the effect of indication of sizes.

### FIELD OF THE INVENTION

The present invention relates to sleeves with indications, in particular to a sleeve with an indication assembly, wherein a toggle is rotatably engaged to a sleeve. The indication is printed on the surfaces of the toggle or the sleeve by laser printing. The indication can be seen easily and be retained for a very longer time.

### BACKGROUND OF THE INVENTION

Currently, there are various kinds of studs, nuts, and spanners with different sizes. To be carried out easily and conveniently, sleeves of different sizes for suiting a D head spanner are developed.

In one prior art, each sleeve formed with two annular recesses. A nose is formed between the two annular recesses. An annular color strip is formed on the nose. The strip is protected by a protection film or a metal ink.

Furthermore, in another prior art, a periphery of a sleeve is formed with a slide stop recess and then a convex texture is formed by rolling process as an indication. A color layer is coated upon a surface of the indication. Then the indication is ground and electroplated.

In above mentioned methods, a color layer is coated upon the sleeve. Then the color layer is coated with a protection film or is electroplated. Normally, the surface of the sleeve is difficult to be cracked or is affected by wetness so that the color strip is wet or the protecting film is destroyed, or the electroplated layer is rusted so that the indications are lose of function. Thereby the above mentioned prior art is not a permanent way for retaining the indications on the sleeve.

Thereby there is an eager demand for a novel way which can improve the prior art defects so that the indication can be retained on the sleeve permanently without being affected by wetness, cracking or collision.

### SUMMARY OF THE INVENTION

Accordingly, the primary object of the present invention is to provide a sleeve with an indication assembly, wherein a toggle is rotatably engaged to a sleeve. The indication is printed on the surfaces of the toggle or the sleeve by laser printing. The indication can be seen easily and be retained for a very longer time.

To achieve above objects, the present invention provides a sleeve with an indication assembly which comprises a sleeve; and a toggle having an inner diameter corresponding to an outer diameter of the sleeve; and the toggle being made of aluminum alloy; a surfaces of the toggle being anodic processed so as to form with a protection film of different colors; thus the surfaces of the toggle is prevented from cracking, collision, blur and falling off. Furthermore, in another case, the toggle has an inner diameter corresponding to an outer diameter of the sleeve; and the toggle is made of iron. A surface of the toggle is electroplated so as to form with a copper layer and then is performed with anodic processing so as to have the effect of indication of sizes.

The various objects and advantages of the present invention will be more readily understood from the following detailed description when read in conjunction with the appended drawing.

### BRIEF DESCRIPTION OF THE DRAWINGS

FIGS. 1-1, 1-2, and 1-3 are schematic views showing the first embodiment of the present invention.

FIGS. 2-1, 2-2, and 2-3 are schematic views showing the second embodiment of the present invention.

FIGS. 3-1, 3-2, and 3-3 are schematic views showing the third embodiment of the present invention.

FIGS. 4-1, and 4-2 are schematic views showing the fourth embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

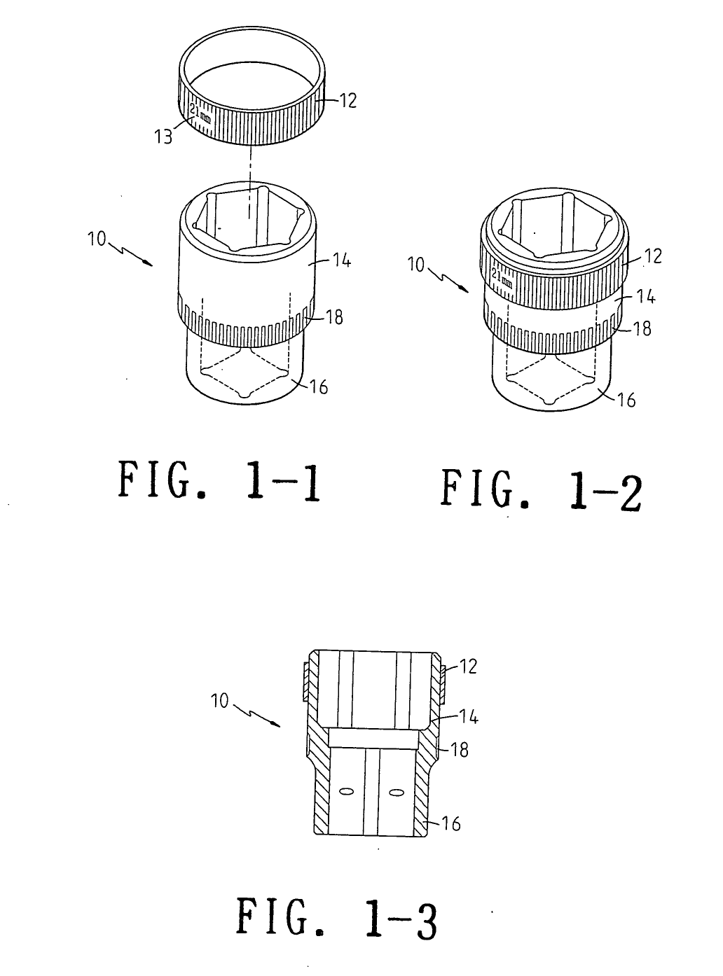

Referring to FIG. 1, the structure of the present invention is illustrated. The present invention has the following elements.

A sleeve 10 and a toggle 12 are made of aluminum alloy, iron, or other metals, which are performed by chemical or electrochemical anodic processing so that a surfaces of the aluminum is formed with a film containing metal. The thickness of the film is about 6μ to 15μ. The feature is that the surfaces of the sleeve 10 and toggle 12 are formed with bright and wear-endurable metal. The metal is oxidized with low chemical activity so as to protect the metal therein. The surfaces may be selected to be bright surfaces or mist surfaces. The surfaces are porous surfaces and have preferred permeation. Thus, the surfaces can be sunk in organic or inorganic dyes or sublimed so as to have beautiful patterns. The dyes will permeate into the holes in the surfaces. Furthermore, when the sleeve 10 and toggle 12 are made of iron, they can be electroplated with a copper bottom layer. Then the sleeve 10 and toggle 12 are performed with anodic processing so as to have a desired quality. Then the size of the sleeve 10 and the toggle 12 after anodic processing are printed with size indications by laser printing. The printing can be retained well without disappear.

Referring to FIG. 1, the sleeve 10 has a large cylinder 14 and a small cylinder 16. An outer periphery of the large cylinder 14 has a trench portion 18. After anodic processing, the toggle 12 can be sleeved around the large cylinder 14. This is the first embodiment of the present invention.

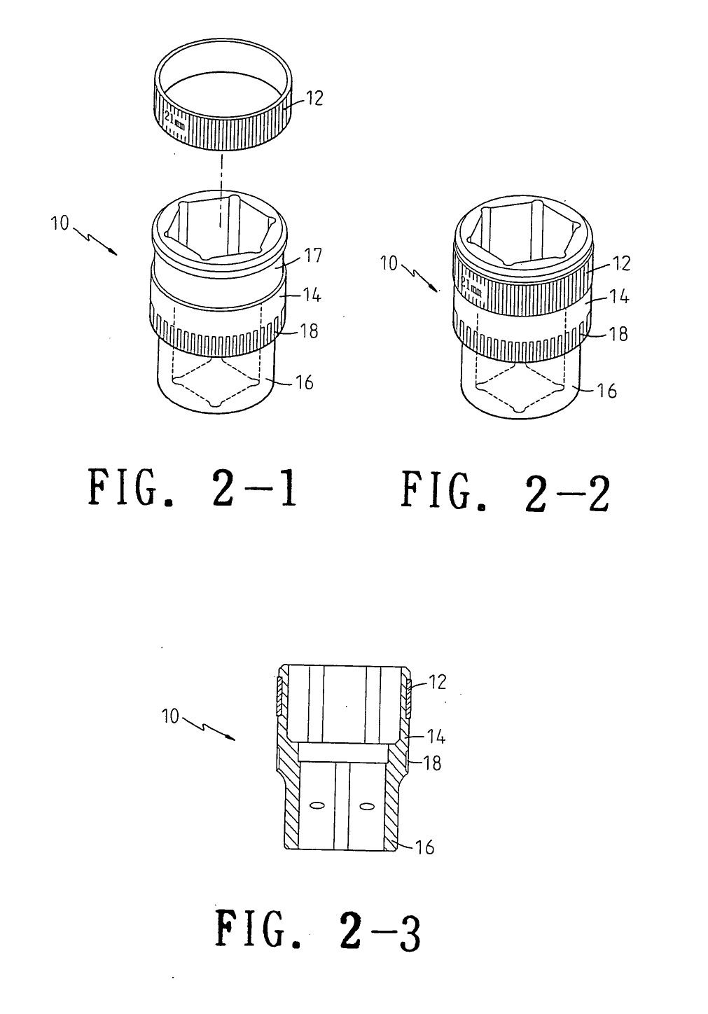

Referring to FIG. 2, the second embodiment of the present invention is illustrated. In the following those identical to the first embodiment will not be described herein. Only those difference are described. In this embodiment, an upper side of the large cylinder 14 is formed with an annular recess 17 for receiving the toggle 12. The toggle 12 is rotatable around a center of the large cylinder 14. Thus the indication on the toggle 12 is movable.

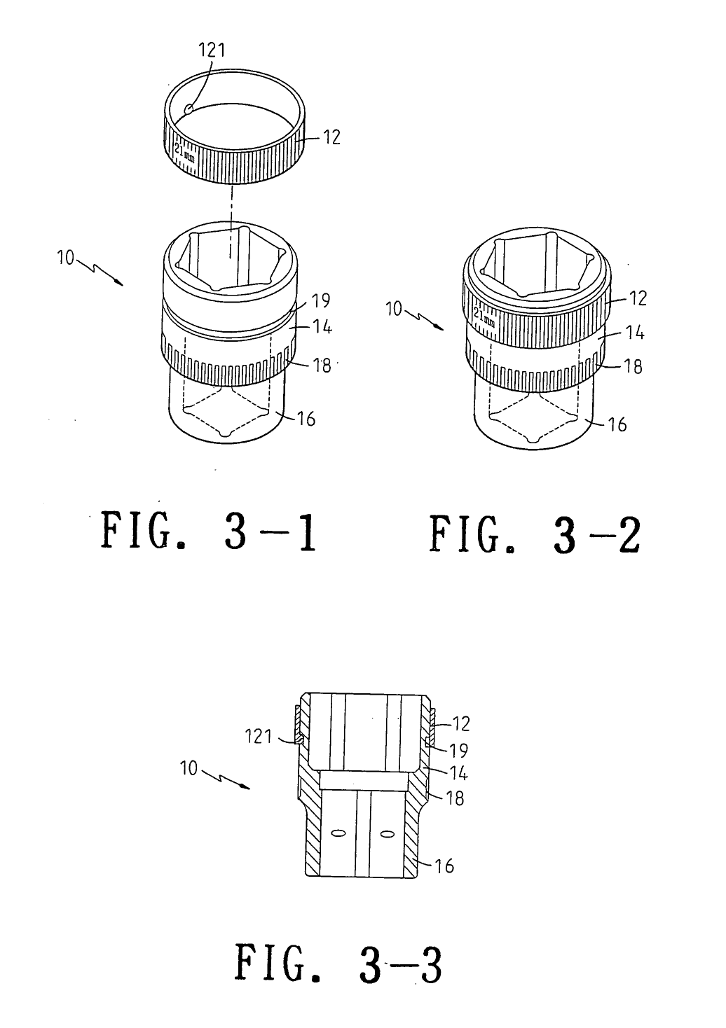

Referring to FIG. 3, the third embodiment of the present invention is illustrated. In the following those identical to the first embodiment will not be described herein. Only those difference are described. An inner lower side of the toggle 12 has a nose 121. The large cylinder 14 has a narrow annular recess 19 for receiving the nose 121. Thereby the annular recess 19 is as a track and the toggle 12 is rotatable along the track. Thus the indication on the toggle 12 is movable.

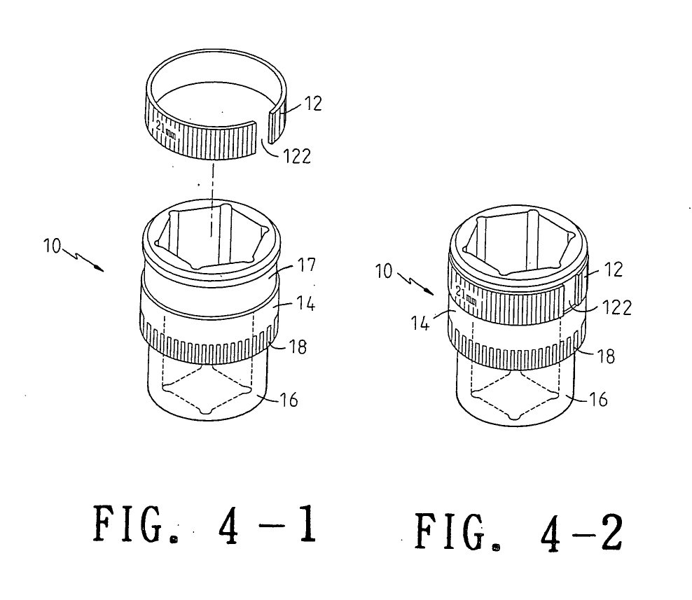

Referring to FIG. 4, the fourth embodiment of the present invention is illustrated. In the following those identical to the first embodiment will not be described herein. Only those difference are described. The large cylinder 14 has an annular recess 17 and the toggle 12 is formed as a C ring with an opening 122. The toggle 12 is rotatably received in the annular recess 17. The user can drive the toggle 12 to move by moving the sides of the opening 122 of the toggle 12.

Thereby in the present invention, by the annular recess 17 and the narrow annular recess 19, the toggle 12 is rotatable. The surface of the toggle 12 has performed with anodic processing. Thus the indication portion 13 will not be cracked or destroyed. Moreover, the anodic processing makes the present invention being made with fewer time and the present invention provides various indications to users.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A sleeve with an indication assembly comprising:
a sleeve;
a toggle having an inner diameter corresponding to an outer diameter of the sleeve; and the toggle being made of aluminum alloy; a surfaces of the toggle being anodic processed so as to form with a protection film of different colors; thus the surfaces of the toggle is prevented from cracking, collision, mist and falling off.

2. A sleeve with an indication assembly comprising:
a sleeve;
a toggle having an inner diameter corresponding to an outer diameter of the sleeve; and the toggle being made of iron; a surface of the toggle being electroplated so as to form with a copper layer and then is performed with anodic processing so as to have the effect of indication of sizes.

3. The sleeve with an indication assembly as claimed in claim 1, wherein after anodic processing, the toggle and the sleeve are printed with size of the sleeve by laser printing.

4. The sleeve with an indication assembly as claimed in claim 1, wherein after anodic processing, the toggle and the sleeve are printed with size of the sleeve by laser printing.

5. The sleeve with an indication assembly as claimed in claim 1, wherein surfaces of the toggle and sleeve are machined with textures or patterns.

6. The sleeve with an indication assembly as claimed in claim 2, wherein surfaces of the toggle and sleeve are machined with textures or patterns.

7. The sleeve with an indication assembly as claimed in claim 1, wherein the toggle is tightly engaged to the sleeve.

8. The sleeve with an indication assembly as claimed in claim 1, wherein the toggle is rotatable engaged to an annular recess of the sleeve.

9. The sleeve with an indication assembly as claimed in claim 1, wherein an inner lower side of the toggle has a nose; the large cylinder has an narrow annular recess for receiving the nose; thereby the annular recess is as a track and the toggle is rotatable along the track.

10. The sleeve with an indication assembly as claimed in claim 1, wherein the toggle is a close ring.

11. The sleeve with an indication assembly as claimed in claim 1, wherein the toggle is a C ring.
